(19) United States
(12) Patent Application Publication
(10) Pub. No.: US 2006/0224832 A1
(43) Pub. Date: Oct. 5, 2006

(54) System and method for performing a prefetch operation

(76) Inventors: Kimming So, Palo Alto, CA (US); Hon-Chong Ho, Fremont, CA (US); Baobinh N. Truong, San Jose, CA (US)

Correspondence Address: MCANDREWS HELD & MALLOY, LTD, 500 WEST MADISON STREET, SUITE 3400, CHICAGO, IL, 60661, US

(21) Appl. No.: 11/302,107

(22) Filed: Dec. 13, 2005

Related U.S. Application Data
(60) Provisional application No. 60/667,481, filed on Apr. 1, 2005.

(51) Int. Cl. G06F 12/00

(52) U.S. Cl. 711/137

(57) ABSTRACT

A system and method to support programmable prefetching of one or more lines of instructions or data into cache storage of a computer system is disclosed. A secondary cache is used to avoid the transfer of a line that is currently being used by the processor. Sequential prefetching is made possible by presetting control registers.

### RELATED APPLICATIONS

[Not Applicable]

### FEDERALLY SPONSORED RESEARCH OR DEVELOPMENT

[Not Applicable]

### [MICROFICHE/COPYRIGHT REFERENCE]

[Not Applicable]

### BACKGROUND OF THE INVENTION

Many computer systems use a prefetch instruction to transfer lines of instructions or data from memory to cache. One disadvantage of using the prefetch instruction may be the possibility that the processor does not immediately use a line in cache, and transferring the line takes up time and cache bandwidth that could be used for other operations. Furthermore, the transferred line may replace a line currently being used by the processor.

Another disadvantage of using the prefetch instruction may be the possibility that the processor requires multiple lines. Code space may be wasted for prefetch instructions, and specifying the line transfer at the correct time adds complexity to a program.

Prefetching may also be done in hardware by automatically transferring lines that are likely to be used by the processor. A disadvantage of hardware prefetching may be the possibility of bringing more lines into the cache than the processor needs, thereby increasing the cache access time and reducing the advantage of caching.

Limitations and disadvantages of conventional and traditional approaches will become apparent to one of skill in the art, through comparison of such systems with some aspects of the present invention as set forth in the present application with reference to the drawings.

### BRIEF SUMMARY OF THE INVENTION

Aspects of the present invention may be found in a computer system with cache storage, substantially as shown in and/or described in connection with at least one of the figures, as set forth more completely in the claims.

These and other advantages, aspects and novel features of the present invention, as well as details of an illustrated embodiment thereof, will be more fully understood from the following description and drawings.

### BRIEF DESCRIPTION OF THE DRAWINGS

FIG. 1 is a block diagram of an exemplary prefetch system for transferring lines of instructions and data in accordance with the present invention;

FIG. 2 is a block diagram of an exemplary secondary cache in accordance with the present invention; and

FIG. 3 is a flowchart illustrating an exemplary method for performing a prefetch operation in accordance with a representative embodiment of the present invention.

### DETAILED DESCRIPTION OF THE INVENTION

Aspects of the present invention relate to performing a prefetch operation. Systems and methods to support programmable prefetching of one or more lines of instructions or data into cache storage of a computer system is disclosed. A secondary cache is used to avoid the transfer of a line that is currently being used by the processor. Sequential prefetching is made possible by presetting control registers.

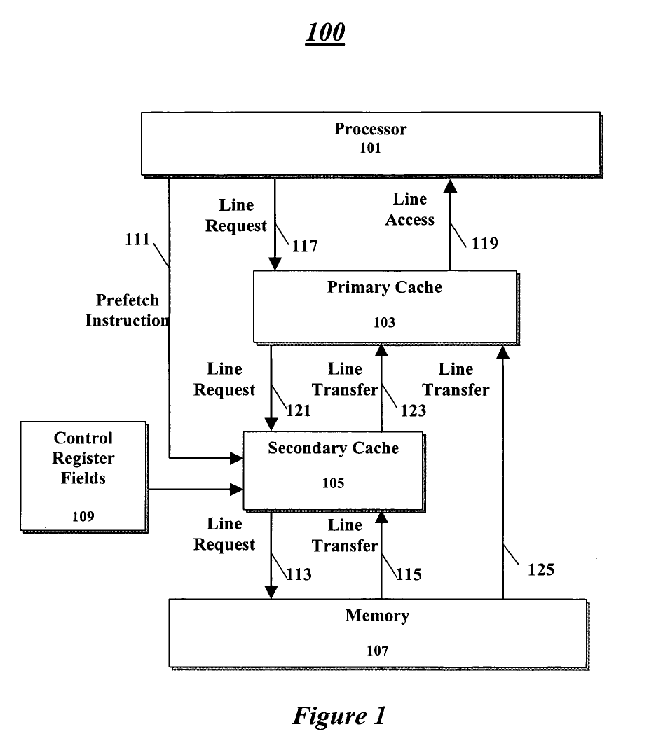

FIG. 1 is a block diagram of an exemplary prefetch system 100 in accordance with the present invention. The prefetch system 100 comprises a processor 101, a primary cache 103, a secondary cache 105, and a memory 107. To execute a program, the processor will request 117 a line by address from the primary cache 103. A line is the storage unit of a cache; it contains a segment of instructions or data. If the requested line is available from the primary cache 103, the processor 101 accesses 119 the line. If the requested line is not in the primary cache 103, a line request 121 is sent to the secondary cache 105. If the requested line is available from the secondary cache 105, the requested line is transferred 123 from the secondary cache to the primary cache. Either the secondary cache 105 or the processor 101 may control the transferring of lines into and out of the secondary cache 105. After the primary cache 103 receives the requested line from the secondary cache 105, the secondary cache 105 is checked for a next line, and if the next line is not already in the secondary cache 105, the next line is transferred from the memory 107 to the secondary cache 105. If the requested line is not available from the secondary cache 105, the requested line is transferred 125 from the memory 107 to the primary cache 103. The line size of the primary cache may be smaller than that of the secondary cache; for example, it can be 32 bytes vs. 128 bytes.

The processor 101 may execute a prefetch instruction 111. In accordance with the prefetch instruction 111 and a plurality of preset control registers 109, a current line may be requested 113 by the secondary cache 105 and may be transferred 115 from the memory 107 during program execution. The current line may be stored by address as one of a plurality of addressed lines in the secondary cache 105.

The processor 101 may access consecutive memory locations sequentially. For example, the current line and the next line may be sequentially addressed. The processor 101 may execute one prefetch instruction 111 for the current line and the next line may be refilled automatically in the background. This may reduce memory latency, and therefore, applications with a significant amount of data streaming can be executed more efficiently.

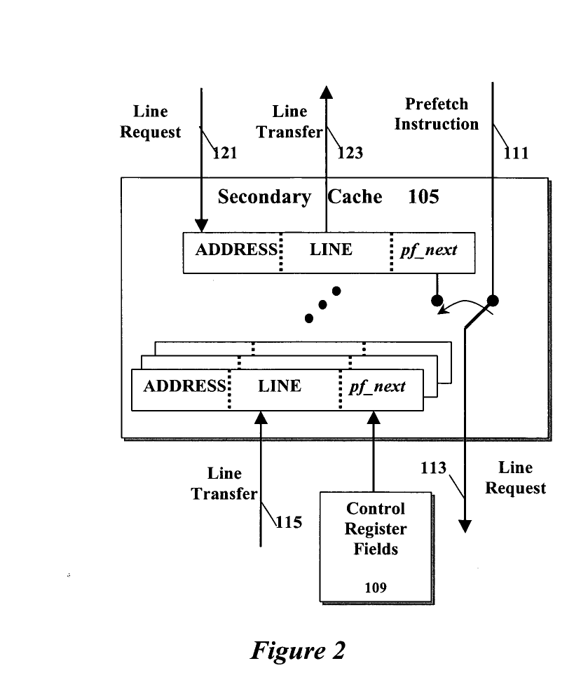

FIG. 2 is a block diagram of an exemplary secondary cache 105 in accordance with the present invention. The secondary cache 105 may be termed “prefetch cache” or “read ahead cache” (RAC).

Line transfer may be controlled by software or hardware. A software prefetch may use the prefetch instruction 111 to specify and transfer the line. The hardware prefetch may automatically transfer lines likely to be used by the processor.

Checking and transferring a sequentially addressed line may be repeated according to one or more field(s) in a control register 109. For example, there may be two fields, SPF and HPF, to control the software and hardware prefetching respectively. Alternatively, prefetching instructions (I) may be distinguished from prefetching data (D) by using 4 fields, SPF_I, SPF_D, HPF_I, and HPF_D.

The SPF field may be set according to a required prefetch duration. Table 1 defines exemplary settings for SPF.

TABLE 1
SPF Setting

| | |
|---|---|
| 0 | No operation |
| 1 | A single prefetch operation |
| 2 | A continuous prefetch operation |

When using the hardware prefetch and the secondary cache 105 is accessed, a line request 113 is sent to memory 107 and the requested line is transferred 115 from memory 107 to the secondary cache 105. The HPF field may be set according to a required prefetch duration. Table 2 defines exemplary settings for HPF.

TABLE 2
HPF Setting

| | |
|---|---|
| 0 | The requested line is sent to the primary cache and |
| | the processor. |
| 1 | The requested line is transferred into the |
| | secondary cache, and the requested line is sent to |
| | the primary cache and the processor. |
| 2 | The requested line is transferred into the |
| | secondary cache, the requested line is sent to the |
| | primary cache and the processor, the next |
| | sequential line is brought into the secondary |
| | cache, and a subsequent access to the next |
| | sequential line will cause a prefetch of the |
| | following sequential line to be brought into the |
| | cache, and so on. |

A line may be stored in the secondary cache 105 with an associated bit, pf_next, that indicates a line request 113. The associated bit, pf_next, may be set according to a field in the control register 109. The value of pf_next may be set when the addressed line is transferred into the secondary cache 105 and may be based on SPF_I, HPF_I, SPF_D, and HPF_D for instruction requests and data requests, respectively. Table 3 defines exemplary settings for pf_next.

TABLE 3
pf_next Setting

| | |
|---|---|
| 0 | No request for the next sequential line is sent to |
| | memory. |
| 1 | A request for the next sequential line is sent to |
| | memory. |

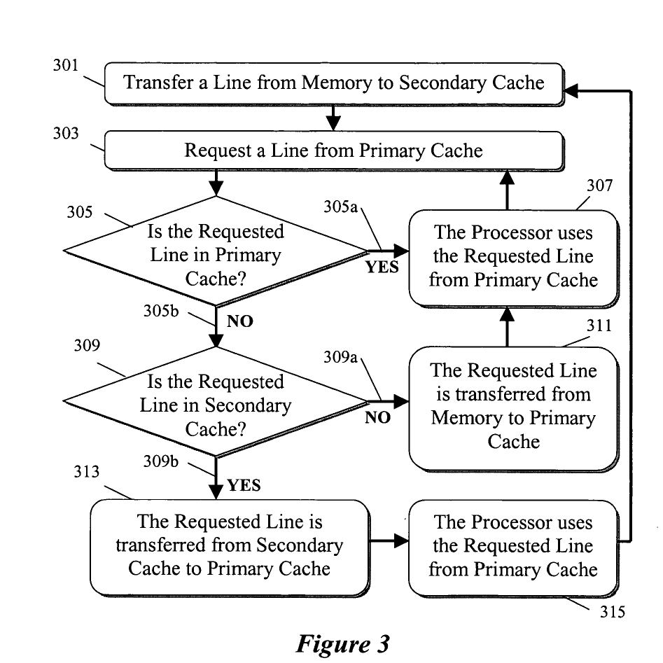

FIG. 3 is a flowchart illustrating an exemplary method for performing a prefetch operation in accordance with a representative embodiment of the present invention. The prefetch method begins by transferring a current line from memory to secondary cache 301. The current line may be stored by address as one of a plurality of addressed lines in secondary cache. After transferring a current line from memory to secondary cache, depending on the value in the SPF Table, if it is ‘1’, the pf value of the line is ‘0’ and there is no request of the next sequential line. If SPF=‘2’, the pf is set to 1, hardware may automatically check secondary cache for a next line, and if the next line is not already in secondary cache, the next line may be transferred from memory to secondary cache, wherein the next line becomes another of the plurality of addressed lines in secondary cache, and again its pf value is set to 1. Subsequently if the processor has a miss of the primary cache and hits the secondary cache. If the line has a pf value of ‘1’, the next sequential line is accessed and fetched into the secondary cache.

The execution of a program may require a line from memory. That line may be requested by address from primary cache 303. If the requested line is in primary cache 305a, the processor may access the requested line from primary cache 307 without requiring a memory transfer that may introduce delay. If a cache miss occurs at primary cache 305b, secondary cache is searched by address for the requested line 309. If a cache miss occurs at secondary cache 309a, the requested line is transferred from memory to primary cache 311, where the processor may access the requested line from primary cache 307.

If the address of the requested line is found in secondary cache 309b, the requested line is transferred from secondary cache to primary cache 313. After transferring the requested line from secondary cache to primary cache, secondary cache may be checked for a next line, and if the next line is not in secondary cache, the next line may be transferred from memory to secondary cache. The next line becomes another of the plurality of addressed lines in secondary cache.

The present invention is not limited to the particular aspects described. Variations of the examples provided above may be applied to a variety of processors without departing from the spirit and scope of the present invention.

Accordingly, the present invention may be realized in hardware, software, or a combination of hardware and software. The present invention may be realized in a centralized fashion in an integrated circuit or in a distributed fashion where different elements are spread across several circuits. Any kind of computer system or other apparatus adapted for carrying out the methods described herein is suited. A typical combination of hardware and software may be a general-purpose computer system with a computer program that, when being loaded and executed, controls the computer system such that it carries out the methods described herein.

The present invention may also be embedded in a computer program product, which comprises all the features enabling the implementation of the methods described herein, and which when loaded in a computer system is able to carry out these methods. Computer program in the present context means any expression, in any language, code or notation, of a set of instructions intended to cause a system having an information processing capability to perform a particular function either directly or after either or both of the following: a) conversion to another language, code or notation; b) reproduction in a different material form.

While the present invention has been described with reference to certain embodiments, it will be understood by those skilled in the art that various changes may be made and equivalents may be substituted without departing from the scope of the present invention. In addition, many modifications may be made to adapt a particular situation or material to the teachings of the present invention without departing from its scope. Therefore, it is intended that the present invention not be limited to the particular embodiment disclosed, but that the present invention will include all embodiments falling within the scope of the appended claims.

The same mechanism can be applied to i) level-0 cache and level-1 cache (primary cache in this embodiment), ii) level-2 cache (also called secondary cache here) and level-3 cache (also called tertiary cache).

What is claimed is:

1. A prefetch system, wherein the system comprises:
a memory;
a primary cache;
a secondary cache for receiving a current line from the memory, wherein the current line is stored by address as one of a plurality of addressed lines in the secondary cache;
a processor for requesting a line by address from the secondary cache, wherein the requested line is not in the primary cache;
if the requested line is in the secondary cache, the primary cache receives the requested line from the secondary cache, else the primary cache receives the requested line from the memory.

2. The prefetch system of claim 1, wherein, after the primary cache receives the requested line from the secondary cache, the secondary cache further:
checks for a next line; and
transfers the next line from the memory to the secondary cache if the next line is not already in the secondary cache.

3. The prefetch system of claim 2, wherein the current line and the next line are sequentially addressed.

4. The prefetch system of claim 3, wherein checking and transferring a sequentially addressed line is repeated according to a control register.

5. The prefetch system of claim 1, wherein transferring is controlled by the secondary cache.

6. The prefetch system of claim 1, wherein transferring is controlled by executing an instruction in the processor.

7. The prefetch system of claim 1, wherein the current line is an instruction.

8. The prefetch system of claim 1, wherein the current line is data.

9. The prefetch system of claim 1, wherein the current line is stored with an associated bit that indicates a line request.

10. The prefetch system of claim 9, wherein the associated bit is set according to a control register.

11. A prefetch method, wherein the method comprises:
transferring a current line from a memory to a secondary cache, wherein the current line is stored by address as one of a plurality of addressed lines in the secondary cache;
if a cache miss occurs at a primary cache, searching by address for a requested line in the secondary cache; and
if the address of the requested line is found in the secondary cache, transferring the requested line from the secondary cache to the primary cache;
else, transferring the requested line from the memory to the primary cache.

12. The prefetch method of claim 11, wherein, after transferring a current line from the memory to the secondary cache, the method further comprises:
checking the secondary cache for a next line; and
if the next line is not in the secondary cache, transferring the next line from the memory to the secondary cache, wherein the next line becomes another of the plurality of addressed lines in the secondary cache.

13. The prefetch method of claim 12, wherein the current line and the next line are sequentially addressed.

14. The prefetch method of claim 13, wherein checking the secondary cache for the next line is repeated according to a control register.

15. The prefetch method of claim 11, wherein, after transferring the requested line from the secondary cache to the primary cache, the method further comprises:
checking the secondary cache for a next line; and
if the next line is not in the secondary cache, transferring the next line from the memory to the secondary cache, wherein the next line becomes another of the plurality of addressed lines in the secondary cache.

16. The prefetch method of claim 15, wherein the current line and the next line are sequentially addressed.

17. The prefetch method of claim 11, wherein transferring is hardware controlled.

18. The prefetch method of claim 11, wherein transferring is software controlled.

19. The prefetch method of claim 11, wherein the current line is an instruction.

20. The prefetch method of claim 11, wherein the current line is data.
